(19) United States
(12) Patent Application Publication
(10) Pub. No.: US 2026/0032542 A1
(43) Pub. Date: Jan. 29, 2026

(54) SMART AND DYNAMIC CELL RESELECTION BASED ON RAN SLICING

(71) Applicant: APPLE INC., Cupertino, CA (US)

(72) Inventors: Srinivas Kote Narasimhamurthy, San Diego, CA (US); Muthukumaran Dhanapal, San Diego, CA (US); Ajoy K. Singh, Milpitas, CA (US); Rohit Mittal, San Diego, CA (US); Alosious Pradeep Prabhakar, Singapore (SG)

(21) Appl. No.: 19/249,333

(22) Filed: Jun. 25, 2025

Related U.S. Application Data
(60) Provisional application No. 63/675,866, filed on Jul. 26, 2024.

(51) Int. Cl. H04W 36/08; H04W 28/02; H04W 64/00

(52) U.S. Cl. CPC H04W 36/08; H04W 28/0284; H04W 64/00

(57) ABSTRACT

Systems and methods for performing smart and dynamic cell reselection based on RAN slicing are disclosed herein. In one aspect, a method for a user equipment (UE) includes, while camped on and registered to a first cell in a cellular network in an idle mode or an inactive state, determining to perform cell reselection based on radio access network (RAN) slicing information. The UE detects low-latency related activity or non low-latency related activity associated with the UE. Responsive to detecting the low-latency related activity, the UE performs an immediate cell reselection process to a slice-specific cell in the cellular network. Responsive to detecting the non low-latency related activity, The UE performs a delayed cell reselection process.

### TECHNICAL FIELD

This application relates generally to wireless communication systems, including systems with radio access network (RAN) slicing.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a flowchart illustrating a method for a UE to perform smart and dynamic cell reselection based on RAN slicing information, according to certain embodiments.

FIG. 2 is a flowchart illustrating a method for a UE, according to certain embodiments.

FIG. 3 is a flowchart illustrating a method for a base station, according to certain embodiments.

FIG. 4 illustrates an example architecture of a wireless communication system, according to embodiments disclosed herein.

FIG. 5 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Based on RAN slicing support in certain wireless systems, a UE may idle reselect to a band, cell, or frequency that is slice supported in a corresponding tracking area (TA) based on network slice access stratum group (NSAG), slice-based cell reselection, and/or slice-based random access channel (RACH) configuration provided by a network (NW) in system information (SI) (e.g., system information block-16 (SIB16) with slice specific information or radio resource control (RRC) dedicated messaging). SIB16 may, for example, carry configuration of slice-specific cell reselection information (i.e., in a sliceInfoList). The NSAG identifies an association to a slice or a set of slices. An NSAG is defined within a TA used for slice-based cell reselection and/or slice-based RACH configuration. Values of NSAG identifiers (IDs) associated with a different slice or a different set of slices are unique within a TA.

A UE may start performing cell reselection evaluation once NSAG information is received in a non-access stratum (NAS) registration procedure and SIB16 (with sliceInfoList) is decoded by the UE. However, this may cause slice supported devices to idle reselect to a slice-based cell and overload the NW in idle mode, which is inefficient. Other scenarios where devices move to slice-based cells include, for example, an idle to connected transition for a slice supported cell, a handover (HO) (e.g., for load balancing reasons) by the NW the UE to a non-slice supported cell, and a connected to idle transition on a non-slice supported cell and then reselection to a slice supported cell. In such cases, the idle UEs and/or load on a slice supported cell increases for the NW, which is inefficient. Also, a UE may “ping pong” multiple times between slice supported cells non-slice supported cells, which may increase the UE's power consumption.

By way of example, a network operator may deploy a selected cell (e.g., n77) for RAN slicing and may support gaming as a slice. If a user subscribes (i.e., buys a plan) for a game slice, then the user's UE may register and get NSAG and UE route selection policy (URSP) rules. The UE may then immediately move to the selected cell (e.g., n77) via reselection. If the user seldom uses a gaming application on the UE, then this may lead to ping pong while using internet data to, for example, perform an idle to connected transition on the selected cell (e.g., n77) that supports slicing, perform HO (e.g., based on NW load balancing) to a non-slice supported cell (e.g., n41), perform a connected to idle transition on the non-slice supported cell (e.g., n41) and then reselect to the slice supported cell (e.g., n77). Thus, the idle UEs and/or load on the slice supported cell (e.g., n77) increases, which is inefficient for the NW. Also, the UE performs a “ping pong” that increases its power consumption.

Idle reselection can be used by a network controller to relieve network congestion by instructing UE(s) in idle mode to switch to less congested cells. For instance, when network overload is detected, a network controller can intervene by encouraging (idle) reselection through adjusting handover parameters, reselection criteria, signaling thresholds, etc., and thus prompting UEs to reselect to network cells with lower congestion levels or better network conditions. Additionally, idle reselection can be tailored to specific network slices or segments. For example, within a sliced virtual network, a reselection process can consider slice-specific parameters, service priorities, and so on, when making cell reselection decisions.

One issue during reselection can be signaling overhead, where frequent cell reselections by idle UE(s) results in increased traffic across multiple cells, leading to network congestion. This can unnecessarily consume network resources and impact the performance of other devices and services associated with the network. In addition, inefficient handover decision-making during the reselection process can exacerbate overhead, leading to ineffective and unnecessary handovers, increasing latency and potential service disruptions.

Signaling overhead can worsen in instances when there are a limited number of available cells, as can be the case within a sliced virtual network. For instance, under 3GPP standards, UE(s) can initiate cell re-selection evaluation upon receiving NSAG information during a NAS registration procedure. The decoding of SIB16 within NSAG information can prompt a UE to re-select to slice-specific cells, which can be limited in quantity. This limited sliced-specific cell issue can increase network overload when slice supported devices frequently idle reselect and transfer to a more limited number of slice-based cells. For instance, within a sliced virtual network, an unnecessary handover can occur from a congested, slice supported cell to a non-slice supported cell, and then back to a (possibly congested) slice supported cell, and so on. This can increase load on all cells, consuming network resources and failing to resolve any congestion issues. Any induced ping pong behavior can also negatively impact power consumption in UEs and the networking system at large.

Aspects and implementations of the present disclosure address the above and additional challenges by providing systems and methods for smart and dynamic cell reselection. In certain embodiments disclosed herein, cell reselection can be based on detection of low-latency related activity at the UE, detection of non low-latency activity at the UE, available RAN slicing information, and/or UE compatibility with a network slice. In certain embodiments, network-induced reselection can be prioritized for certain UE(s) based on specific information derived from the UE, such as compatibility and detection of low-latency related activity (e.g., ultra reliable and low latency communications (URLLC)) at the UE. Low-latency related activity at the UE can be detected either by direct verification of an application in use, or by secondary information (e.g., a set of rules) for detecting usage of a low-latency application or activity. Similarly, non low-latency related activity (e.g., enhanced mobile broadband (eMBB)) at the UE can be detected either by direct verification of an application in use or by secondary information (e.g., a set of rules).

For UEs for which cell reselection is prioritized, cell reselection to a slice supported cell can be immediate. For UEs that are not prioritized, cell reselection can be delayed. Otherwise stated, when a UE moves to idle and needs to reselect, immediate reselection can be performed only for UEs for which low latency related activity (e.g., URLLC) has been detected. Immediate, or prioritized, reselection can be based on RAN slicing information available (e.g., frequency, cell, tracking area identity (TAI), and/or single-network slice selection assistance information (S-NSSAI)) from the NW.

In certain embodiments, as set of rules for identifying low-latency related activity at the UE and/or prioritizing UE(s) for slice supported cell reselection is provided. Should one or more of the rules be met, a prioritized reselection strategy can be used for that UE. For example, certain UE(s) can include different profile settings that are configurable by a user of the UE.

One such example can be a “game focus mode.” For instance, for certain devices, users can set a profile “focus mode” in a settings menu as “gaming.” This setting can engage a configuration which will be detected as a low-latency application/related data activity mode. When such a focus mode is set, the network can prioritize the UE, and can seek to use the (immediate) RAN assisted slice based cell re-selection method.

In certain embodiments, a similar prioritized status can be indicated by the UE's most recently used (MRU) application. For instance, in cases where an MRU application (before moving to idle) is a low-latency based application, the UE can be prioritized. During congestion-driven reselection, the UE can be transferred to slice-specific cell via the prioritized method. A similar prioritization status and reselection method can be assigned when a low-latency related application is in a background of the UE (e.g., when an app screen is pushed back).

In further embodiments, a device learning approach can be used. For example, a prediction or likelihood of the usage of low-latency applications by a UE or user can be made based on the UE's geographical location, time of day, etc.

Other rules, or methods, to detect low-latency related activity at the UE and/or prioritizing UE(s) for cell reselection can include a recognition of latency sensitive hardware at the UE. For instance, identification of one or more components (e.g., such as an N301: hot spot client) can indicate an association (and/or requirement) of the UE with low-latency network activity. In some embodiments, a UE can also be prioritized based on device specific information such as NSAG-ID (re-selection can be prioritized if the NSAG ID info in the sliceInfoList supports the low-latency slice) or a physical location associated with a network congested area (e.g., reselection can be prioritized based on location database number of UE's and UE throughput).

In certain embodiments, non low-latency related activity (e.g., eMBB) at the UE can be detected either by direct verification of an application in use, or by secondary information (e.g., a set of rules). For instance, in embodiments, non low-latency related activity at the UE can be detected by verifying whether the UE includes an MRU application that is non low-latency based, by verifying that no low-latency applications are detected in the background, and/or based on NSAG-ID information. For example, non low-latency related activity at the UE can be detected if the NSAG ID info in the “sliceInfoList” does not support the low-latency slices.

Should non low-latency related activity at the UE be detected, and/or should low-latency related activity fail to be detected, a deprioritized or delayed, reselection strategy can be used for that UE. For example, in some cases an idle reselect can be delayed until data packets arrive at one or more buffers allocated on either or both the application (AP) processor side or the baseband (BB) processor side (incoming to the device or outgoing from the device).

Should a delayed reselection strategy be applied, yet an RRC (radio resource control) connection establish due to data packet arrival, then a UE can prioritize connected mode measurements on these RAN slicing supported cells such that handover to the cell can be triggered sooner.

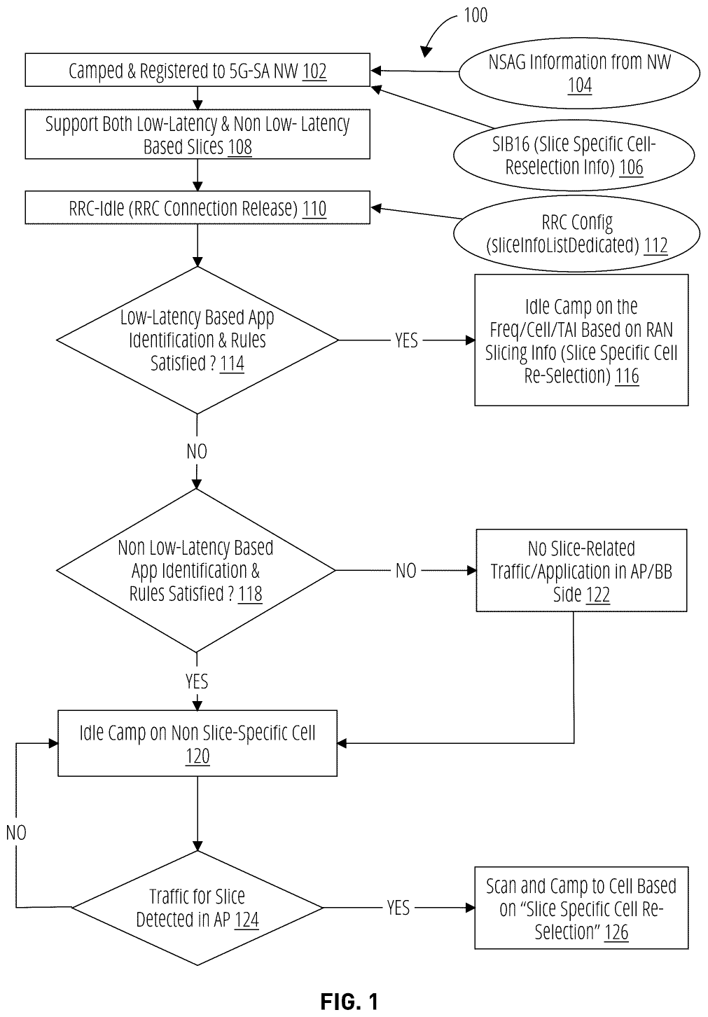

FIG. 1 is a flowchart illustrating a method 100 for a UE to perform smart and dynamic cell reselection based on RAN slicing information, according to certain embodiments. In certain embodiments, the method 100 can be performed by a UE and a wireless communication system. At block 102, the method 100 can begin with a UE camping and registering to a 5G-SA (standalone) network. The UE receives NSAG Information 104 and SIB16 106 from the network.

At block 108, the method 100 further includes verifying that the network supports both low-latency and non low-latency based slices. This can include verifying which slices the UE is compatible with. At block 110, the UE enters an RRC-idle state (e.g., RRC connection release). In the RRC-idle state, the UE may receive RRC configuration information 112 including slice information (e.g., sliceInfoListDedicated).

At decision block 114, the method 100 includes detecting the presence of low-latency related activity at the UE, which can include detecting whether a low-latency based application is in use and/or whether a set of rules is met. For instance, the UE may be examined to detect low-latency related activity (e.g., whether application activity is associated with low-latency network requirements). In certain embodiments, meeting at least one rule of the set of rules can be used to trigger a prioritized, or immediate, cell reselection strategy.

In some embodiments, the set of rules for identifying low-latency related UE activity can include detecting the engagement of a “game focus mode” or similar within a setting of the UE. For instance, in certain iOS device(s), users can set a profile setting as “gaming,” which can be used to indicate low-latency related UE activity. In adherence with a first set of rules, when such a profile setting (or similar setting) is detected, the immediate, or prioritized, reselection process can be selected. Otherwise state, the UE can then perform RAN assisted slice-based cell reselection (as seen at block 116).

Further rules for detecting low-latency related activity at the UE can include examining the most recently used (MRU) application, to verify whether it is a low-latency based application. For instance, when a last used application of the UE, before moving to idle, is low-latency based application, then the immediate, or prioritized, reselection process can be selected for use.

The set of rules for detecting low-latency related activity at the UE can further include verifying whether one or more applications in the background is/are low-latency related applications. For instance, when a low-latency related application is in the background (e.g., when the application main screen is pushed back), then the immediate, or prioritized, reselection process can be selected for use.

The set of rules for detecting low-latency related activity at the UE can further include a predicted used of a low-latency related application, e.g., through device learning. For instance, the usage of a low-latency related application can be predicted based on the geographical location, time of day, etc., associated with the UE. Should usage of a low-latency related application be predicted, the immediate, or prioritized, reselection process can be selected for use.

The set of rules for detecting low-latency related activity at the UE can further include the identification of certain low-latency related hardware associated with the device. For instance, detection of low-latency related hardware (e.g., such as an N301 or hot spot client) can trigger a selection of the immediate, or prioritized, reselection process for use.

The set of rules for detecting low-latency related activity at the UE can further include extraction of an indicator from within NSAG-ID information. For instance, in embodiments, if the NSAG-ID information within the “sliceInfoList” supports low-latency slices, the immediate, or prioritized, reselection process can be selected for use.

The set of rules for detecting low-latency related activity at the UE can further include identification of a network congested area. For instance, a network congested area can be determined or identified based on location database number of UEs and UE throughput. The immediate, or prioritized, reselection process can then be selected for use for one or more UEs at the network congested area.

Positively detecting or verifying the presence of low-latency related activity at the UE (which can include verifying whether a low-latency based application is in use and/or whether a set of rules is met) triggers block 116. For instance, in embodiments, satisfying at least one rule within the set of rules can signal to execute block 116. At block 116, the method 100 includes idle camping on the frequency, cell, or TAI based on the RAN slicing information (i.e., slice specific cell reselection). If the conditions to advance to block 116 are not met, method 100 can advance to decision block 118.

At decision block 118, the method 100 includes positively detecting non low-latency related activity at the UE, which can include detecting whether a non low-latency based application is in use and/or whether a set of rules (e.g., the same as or separate from the rules of decision block 114) are met. For instance, the UE may detect non low-latency related UE activity (e.g., whether application activity is not associated with low-latency network requirements). In certain embodiments, meeting at least one rule of the set of rules can be used to trigger a non-prioritized, or delayed, cell-reselection strategy. Detecting non low-latency related activity at the UE can signal to execute block 120. In embodiments, satisfying at least one rule of the set of rules can signal to execute block 120.

In certain embodiments, the rules for detecting non low-latency related activity at the UE can include verifying whether the MRU application is a non low-latency related application. The rules can further include a rule that includes detecting that no low-latency related applications are in the background. The rules can further include a rule that includes detecting whether the NSAG-ID info in the sliceInfoList fails to support the low-latency slices. Should low latency slices fail to be supported, the UE can be directed to idle camp on a non slice-specific cell.

Should non low-latency related activity at the UE be detected (e.g., either through verification of a non low-latency based application in use and/or positively satisfying one or more rules within the set of rules), the UE idle camps on a non slice-specific cell e.g., at block 120 of the method 100. Block 120 can include initiating an idle camp on a non-slice specific cell.

In cases where non low-latency related activity at the UE is not detected, the method 100 can advance to block 122, in which a first delay can be introduced. For instance, at block 122 cell-reselection can be delayed until a condition is met. The condition can include detection of an absence of slice-related traffic related to the application in one or more buffers, allocated on either or both the AP side and the BB side. Otherwise stated, cell-reselection can be delayed until the absence of slice-related traffic is detected within the one or more buffers. Once the absence of slice-related traffic is detected within the one or more buffers, the UE can move to block 120. Should slice-related traffic remain present in the one or more buffers, the UE can remain in a delaying (non-reselection) state until absence is detected.

At block 120 the UE can remain registered and/or camped on a non slice-specific cell. This state can continue until slice-related traffic related to the application is detected in the one or more buffers, allocated on either or both the AP side and the BB side. The state at 120 can be maintained via decision block 124. For example, the decision block 124 can include verifying whether traffic for a slice (i.e., slice-related traffic) has been detected in one of the buffers. Should traffic continue to be non slice-related, the UE can return to block 120, and remain registered and/or camped on a non slice-specific cell. Should traffic within the one or more buffers be detected to be slice-specific, the method 100 can advance to block 126.

At block 126, the method 100 includes scanning and camping to a slice-specific cell, based on a slice-specific cell re-selection process.

The smart and dynamic cell reselection method 100 based on RAN slicing shown in FIG. 1 allows the UE to efficiently choose between camping on a slice-supported cell or a non-slice supported cell. The method 100 reduces or avoids NW overloading or congestion, avoids frequent ping pong, and provides efficient handling of idle cell reselection.

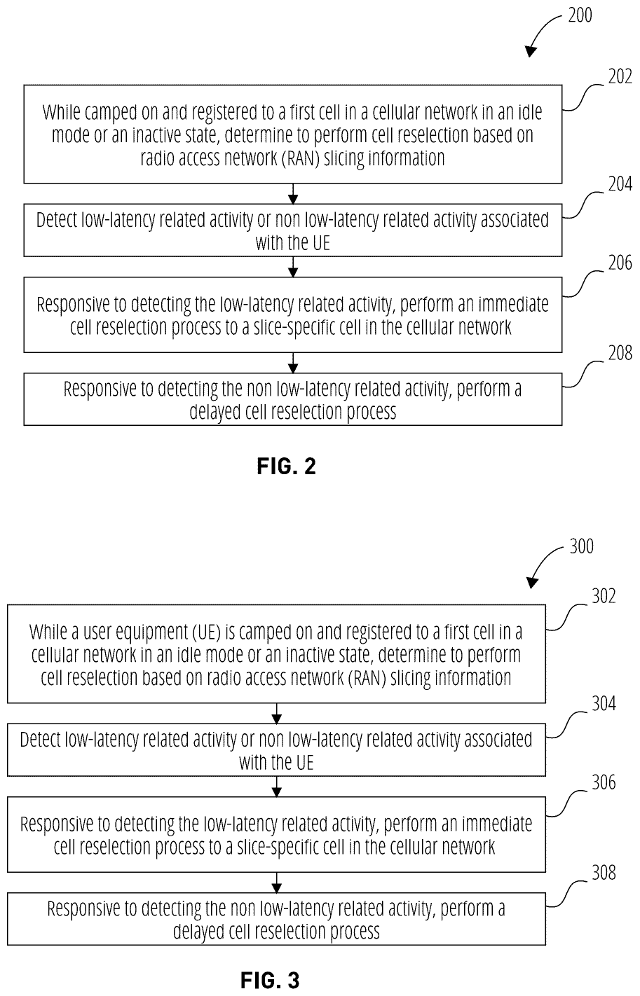

FIG. 2 is a flowchart illustrating a method 200 for a UE, according to certain embodiments. While camped on and registered to a first cell in a cellular network in an idle mode or an inactive state, the method 200 includes determining 202 to perform cell reselection based on radio access network (RAN) slicing information. The method 200 also includes detecting 204 low-latency related activity or non low-latency related activity associated with the UE. Responsive to detecting the low-latency related activity, the method 200 includes performing 206 an immediate cell reselection process to a slice-specific cell in the cellular network. Responsive to detecting the non low-latency related activity, the method 200 includes performing 208 a delayed cell reselection process.

In some embodiments of the method 200, responsive to a lack of detecting the low-latency related activity and a lack of detecting the non low-latency related activity, the method 200 further includes performing the delayed cell reselection process.

In some embodiments of the method 200, detecting the low-latency related activity associated with the UE includes detecting a low-latency based application associated with the UE.

In some embodiments of the method 200, detecting the low-latency related activity associated with the UE includes detecting user engagement of a low-latency related mode of the UE, detecting a most recent used (MRU) application of the UE that is a low-latency based application, detecting a low-latency based application in the background of the UE, detecting a client-based latency sensitive hardware component of the UE, or detecting an indication that the UE supports a low-latency network slice.

In some embodiments of the method 200, detecting the low-latency related activity associated with the UE includes predicting a usage of a low-latency based application associated with the UE.

In some embodiments of the method 200, detecting the low-latency related activity associated with the UE includes predicting a usage of a low-latency based application associated with the UE based on a geographical location of the UE or a time corresponding to the time-zone associated with the device.

In some embodiments of the method 200, detecting the low-latency related activity associated with the UE includes detecting an indication that a network area of the 5G-SA network which the UE is registered to is congested.

In some embodiments of the method 200, detecting the non low-latency related activity associated with the UE includes detecting a most recent used (MRU) application of the UE that is a non low-latency based application, detecting a non low-latency based application in the background of the UE, or detecting an indication that the UE fails to support a low-latency network slice.

In some embodiments of the method 200, performing the immediate cell reselection process to a slice-specific cell in the cellular network includes executing an idle camp to a new serving cell based on available RAN slicing information.

In some embodiments of the method 200, performing the delayed cell reselection process includes: performing cell reselection to a non slice-specific cell in the cellular network, and monitoring network traffic at a buffer associated with the UE. Performing the delayed cell reselection process may also include detecting the presence of network traffic includes slice-related traffic at the buffer, and responsive to detecting the presence of slice-related traffic, performing cell reselection to a slice-specific cell based on available RAN slicing information.

Embodiments contemplated herein include an apparatus comprising means to perform one or more elements of the method 200. This apparatus may be, for example, an apparatus of a UE (such as a wireless device 502 that is a UE, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a UE (such as a memory 506 of a wireless device 502 that is a UE, as described herein).

Embodiments contemplated herein include an apparatus comprising logic, modules, or circuitry to perform one or more elements of the method 200. This apparatus may be, for example, an apparatus of a UE (such as a wireless device 502 that is a UE, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a UE (such as a wireless device 502 that is a UE, as described herein).

Embodiments contemplated herein include a signal as described in or related to one or more elements of the method 200.

Embodiments contemplated herein include a computer program or computer program product comprising instructions, wherein execution of the program by a processor is to cause the processor to carry out one or more elements of the method 200. The processor may be a processor of a UE (such as a processor(s) 504 of a wireless device 502 that is a UE, as described herein). These instructions may be, for example, located in the processor and/or on a memory of the UE (such as a memory 506 of a wireless device 502 that is a UE, as described herein).

FIG. 3 is a flowchart illustrating a method 300 for a base station, according to certain embodiments. In determining 302, while camped on and registered to a first cell in a cellular network in an idle mode or an inactive state, the method 300 includes determining 302 to perform cell reselection based on radio access network (RAN) slicing information. The method 300 further includes detecting 304 low-latency related activity or non low-latency related activity associated with the UE. Responsive to detecting the low-latency related activity, the method 300 includes performing 306 an immediate cell reselection process to a slice-specific cell in the cellular network. In responsive to detecting the detection of non low-latency related activity or a lack of detection of low-latency related activity, the method 300 includes performing 308 a delayed cell reselection process.

In some embodiments of the method 300, the method may further include, responsive to a lack of detecting the low-latency related activity and a lack of detecting the non low-latency related activity, performing the delayed cell reselection process.

In some embodiments of the method 300, detecting the low-latency related activity associated with the UE includes detecting a low-latency based application associated with the UE.

In some embodiments of the method 300, detecting the low-latency related activity associated with the UE includes detecting user engagement of a low-latency related mode of the UE, detecting a most recent used (MRU) application of the UE that is a low-latency based application, detecting a low-latency based application in the background of the UE, detecting a client-based latency sensitive hardware component of the UE, or detecting an indication that the UE supports a low-latency network slice.

In some embodiments of the method 300, detecting the low-latency related activity associated with the UE includes predicting a usage of a low-latency based application associated with the UE.

In some embodiments of the method 300, detecting the low-latency related activity associated with the UE includes predicting a usage of a low-latency based application associated with the UE based on a geographical location of the UE or a time corresponding to the time zone associated with the device.

In some embodiments of the method 300, detecting the low-latency related activity associated with the UE includes detecting an indication that a network area of the 5G-SA network which the UE is registered to is congested.

In some embodiments of the method 300, detecting the non low-latency related activity associated with the UE includes detecting a most recent used (MRU) application of the UE that is a non low-latency based application, detecting a non low-latency based application in the background of the UE, or detecting an indication that the UE fails to support a low-latency network slice.

In some embodiments of the method 300, performing the immediate cell reselection process to a slice-specific cell in the cellular network includes executing an idle camp to a new serving cell based on available RAN slicing information.

In some embodiments of the method 300, performing the delayed cell reselection process includes performing cell reselection to a non slice-specific cell in the cellular network, and monitoring network traffic at a buffer associated with the UE. Performing the delayed cell reselection process may also include detecting the presence of network traffic includes slice-related traffic at the buffer, and responsive to detecting the presence of slice-related traffic, performing cell reselection to a slice-specific cell based on available RAN slicing information.

Embodiments contemplated herein include an apparatus comprising means to perform one or more elements of the method 300. This apparatus may be, for example, an apparatus of a base station.

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a base station (such as a memory 522 of a network device 518 that is a base station, as described herein).

Embodiments contemplated herein include an apparatus comprising logic, modules, or circuitry to perform one or more elements of the method 300. This apparatus may be, for example, an apparatus of a base station (such as a network device 518 that is a base station, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a base station (such as a network device 518 that is a base station, as described herein).

Embodiments contemplated herein include a signal as described in or related to one or more elements of the method 300.

Embodiments contemplated herein include a computer program or computer program product comprising instructions, wherein execution of the program by a processing element is to cause the processing element to carry out one or more elements of the method 300. The processor may be a processor of a base station (such as a processor(s) 520 of a network device 518 that is a base station, as described herein). These instructions may be, for example, located in the processor and/or on a memory of the base station (such as a memory 522 of a network device 518 that is a base station, as described herein).

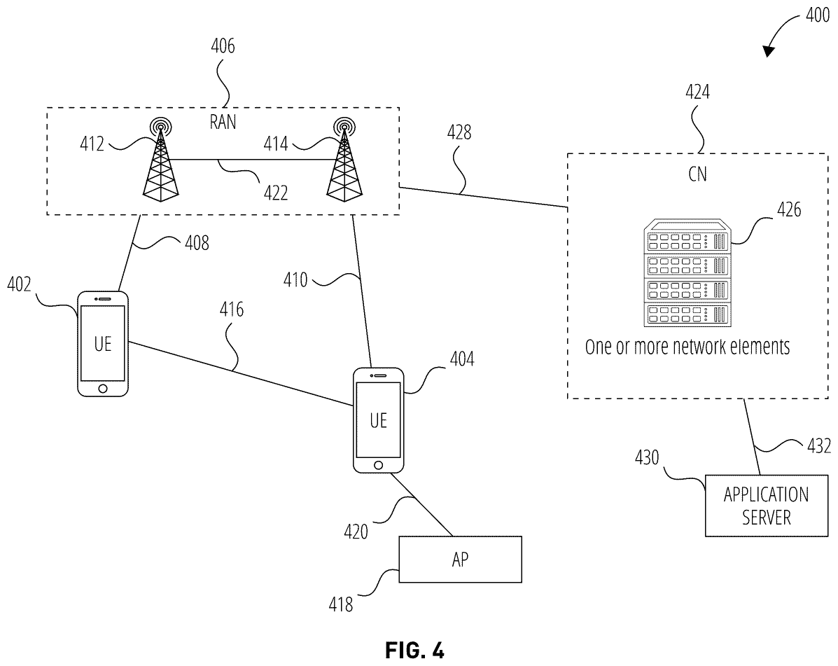

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks) but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations (such as base station 412 and base station 414) that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-FiR router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the S1 control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VoIP sessions, group communication sessions, etc.) for the UE 402 and UE 404 via the CN 424. The application server 430 may communicate with the CN 424 through an IP communications interface 432.

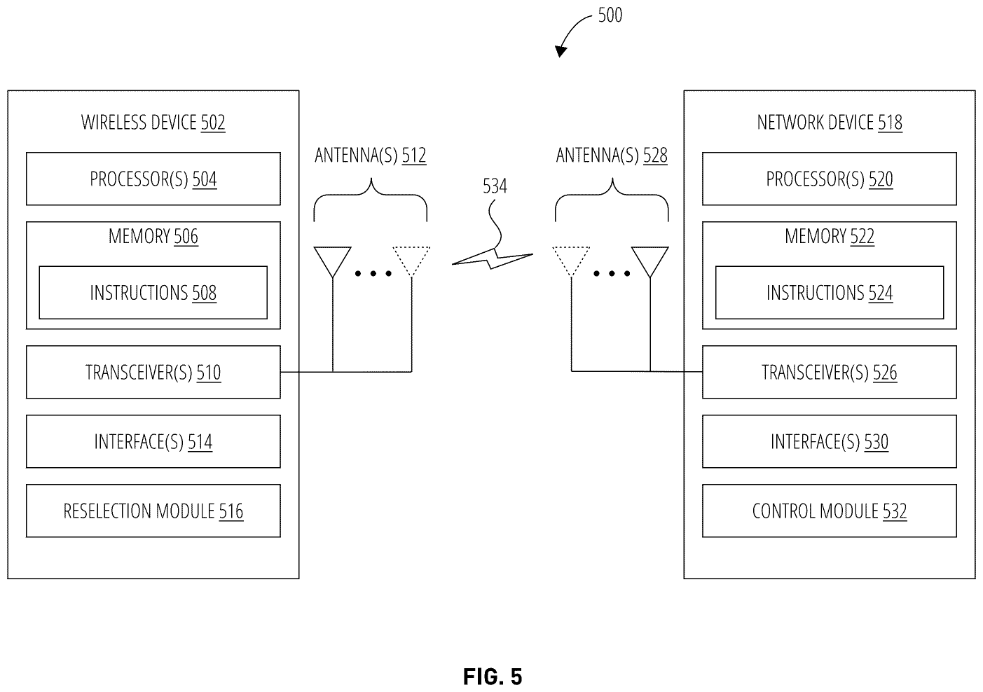

FIG. 5 illustrates a system 500 for performing signaling 534 between a wireless device 502 and a network device 518, according to embodiments disclosed herein. The system 500 may be a portion of a wireless communications system as herein described. The wireless device 502 may be, for example, a UE of a wireless communication system. The network device 518 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter circuitry and/or receiver circuitry that use the antenna(s) 512 of the wireless device 502 to facilitate signaling (e.g., the signaling 534) to and/or from the wireless device 502 with other devices (e.g., the network device 518) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth®, and the like).

The wireless device 502 may include a reselection module 516. The reselection module 516 may be implemented via hardware, software, or combinations thereof. For example, the reselection module 516 may be implemented as a processor, circuit, and/or instructions 508 stored in the memory 506 and executed by the processor(s) 504. In some examples, the reselection module 516 may be integrated within the processor(s) 504 and/or the transceiver(s) 510. For example, the reselection module 516 may be implemented by a combination of software components (e.g., executed by a DSP or a general processor) and hardware components (e.g., logic gates and circuitry) within the processor(s) 504 or the transceiver(s) 510.

The reselection module 516 may be used for various aspects of the present disclosure, for example, aspects of FIG. 1. The reselection module 516 is configured to perform smart and dynamic cell re-selection based on RAN slicing.

The network device 518 may include one or more processor(s) 520. The processor(s) 520 may execute instructions such that various operations of the network device 518 are performed, as described herein. The processor(s) 520 may include one or more baseband processors implemented using, for example, a CPU, a DSP, an ASIC, a controller, an FPGA device, another hardware device, a firmware device, or any combination thereof configured to perform the operations described herein.

The network device 518 may include a memory 522. The memory 522 may be a non-transitory computer-readable storage medium that stores instructions 524 (which may include, for example, the instructions being executed by the processor(s) 520). The instructions 524 may also be referred to as program code or a computer program. The memory 522 may also store data used by, and results computed by, the processor(s) 520.

The network device 518 may include one or more transceiver(s) 526 that may include RF transmitter circuitry and/or receiver circuitry that use the antenna(s) 528 of the network device 518 to facilitate signaling (e.g., the signaling 534) to and/or from the network device 518 with other devices (e.g., the wireless device 502) according to corresponding RATs.

The network device 518 may include one or more antenna(s) 528 (e.g., one, two, four, or more). In embodiments having multiple antenna(s) 528, the network device 518 may perform MIMO, digital beamforming, analog beamforming, beam steering, etc., as has been described.

The network device 518 may include one or more interface(s) 530. The interface(s) 530 may be used to provide input to or output from the network device 518. For example, a network device 518 that is a base station may include interface(s) 530 made up of transmitters, receivers, and other circuitry (e.g., other than the transceiver(s) 526/antenna(s) 528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 518 may include a control module 532. The control module 532 may be implemented via hardware, software, or combinations thereof. For example, the control module 532 may be implemented as a processor, circuit, and/or instructions 524 stored in the memory 522 and executed by the processor(s) 520. In some examples, the control module 532 may be integrated within the processor(s) 520 and/or the transceiver(s) 526. For example, the control module 532 may be implemented by a combination of software components (e.g., executed by a DSP or a general processor) and hardware components (e.g., logic gates and circuitry) within the processor(s) 520 or the transceiver(s) 526.

The control module 532 may be used for various aspects of the present disclosure, for example, aspects of FIGS. 1-3. The control module 532 is configured to encourage, instruct, or otherwise cause smart and dynamic cell re-selection based on RAN slicing to be performed.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), comprising:
while camped on and registered to a first cell in a cellular network in an idle mode or an inactive state, determining to perform cell reselection based on radio access network (RAN) slicing information;
detecting low-latency related activity or non low-latency related activity associated with the UE;
responsive to detecting the low-latency related activity, performing an immediate cell reselection process to a slice-specific cell in the cellular network; and
responsive to detecting the non low-latency related activity, performing a delayed cell reselection process.

2. The method of claim 1, further comprising:
responsive to a lack of detecting the low-latency related activity and a lack of detecting the non low-latency related activity, performing the delayed cell reselection process.

3. The method of claim 1, wherein detecting the low-latency related activity associated with the UE comprises detecting a low-latency based application associated with the UE.

4. The method of claim 1, wherein detecting the low-latency related activity associated with the UE comprises detecting user engagement of a low-latency related mode of the UE, detecting a most recent used (MRU) application of the UE that is a low-latency based application, detecting a low-latency based application in a background of the UE, detecting a client-based latency sensitive hardware component of the UE, or detecting an indication that the UE supports a low-latency network slice.

5. The method of claim 1, wherein detecting the low-latency related activity associated with the UE comprises predicting a usage of a low-latency based application associated with the UE.

6. The method of claim 1, wherein detecting the low-latency related activity associated with the UE comprises predicting a usage of a low-latency based application associated with the UE based on a geographical location of the UE or a time corresponding to the time-zone associated with the UE.

7. The method of claim 1, wherein detecting the low-latency related activity associated with the UE comprises detecting an indication that a network area of the 5G-SA network which the UE is registered to is congested.

8. The method of claim 1, wherein detecting the non low-latency related activity associated with the UE comprises detecting a most recent used (MRU) application of the UE that is a non low-latency based application, detecting a non low-latency based application in a background of the UE, or detecting an indication that the UE fails to support a low-latency network slice.

9. The method of claim 1, wherein performing the immediate cell reselection process to the slice-specific cell in the cellular network comprises executing an idle camp to a new serving cell based on available RAN slicing information.

10. The method of claim 1, wherein performing the delayed cell reselection process comprises:
performing cell reselection to a non slice-specific cell in the cellular network; and
monitoring network traffic at a buffer associated with the UE.

11. The method of claim 10, wherein performing the delayed cell reselection process further comprises:
detecting a presence of network traffic comprising slice-related traffic at the buffer; and
responsive to detecting the presence of the network traffic comprising the slice-related traffic, performing cell reselection to a slice-specific cell based on available RAN slicing information.

12. A method for a base station of a cellular network, the method comprising:
while a user equipment (UE) is camped on and registered to a first cell in a cellular network in an idle mode or an inactive state, determining to perform cell reselection based on radio access network (RAN) slicing information;
detecting low-latency related activity or non low-latency related activity associated with the UE;
responsive to detecting the low-latency related activity, performing an immediate cell reselection process to a slice-specific cell in the cellular network; and
responsive to detecting the non low-latency related activity, performing a delayed cell reselection process.

13. The method of claim 12, further comprising:
responsive to a lack of detecting the low-latency related activity and a lack of detecting the non low-latency related activity, performing the delayed cell reselection process.

14. The method of claim 12, wherein detecting the low-latency related activity associated with the UE comprises detecting a low-latency based application associated with the UE.

15. The method of claim 12, wherein detecting the low-latency related activity associated with the UE comprises detecting user engagement of a low-latency related mode of the UE, detecting a most recent used (MRU) application of the UE that is a low-latency based application, detecting a low-latency based application in a background of the UE, detecting a client-based latency sensitive hardware component of the UE, or detecting an indication that the UE supports a low-latency network slice.

16. The method of claim 12, wherein detecting the low-latency related activity associated with the UE comprises predicting a usage of a low-latency based application associated with the UE.

17. The method of claim 12, wherein detecting the low-latency related activity associated with the UE comprises predicting a usage of a low-latency based application associated with the UE based on a geographical location of the UE or a time corresponding to the time-zone associated with the UE.

18. The method of claim 12, wherein detecting the low-latency related activity associated with the UE comprises detecting an indication that a network area of the 5G-SA network which the UE is registered to is congested.

19. The method of claim 12, wherein detecting the non low-latency related activity associated with the UE comprises detecting a most recent used (MRU) application of the UE that is a non low-latency based application, detecting a non low-latency based application in a background of the UE, or detecting an indication that the UE fails to support a low-latency network slice.

20. The method of claim 12, wherein performing the immediate cell reselection process to the slice-specific cell in the cellular network comprises executing an idle camp to a new serving cell based on available RAN slicing information.
